(19) United States
(12) Patent Application Publication
(10) Pub. No.: US 2024/0031528 A1
(43) Pub. Date: Jan. 25, 2024

(54) MULTI-PLATFORM WEB-EVENT HOSTING AND PRODUCTION PROCESS

(71) Applicant: Benjamin Nowak, Atlanta, GA (US)

(72) Inventor: Benjamin Nowak, Atlanta, GA (US)

(21) Appl. No.: 18/356,542

(22) Filed: Jul. 21, 2023

Related U.S. Application Data
(60) Provisional application No. 63/391,145, filed on Jul. 21, 2022.

(51) Int. Cl. H04N 7/14; H04N 7/15

(52) U.S. Cl. CPC H04N 7/147; H04N 7/15

(57) ABSTRACT

Multi-platform Web-event Hosting and Production comprising: receiving a plurality of audience data feed from a plurality of different sources, wherein each of the plurality of data feeds comprises at least one of video data and audio data corresponding to a hosted event, extracting data associated with at least one of the audio and the video data from the audience feed, generating an audience interaction platform corresponding to the data extracted from the plurality of users, incorporating the data from the audience interaction platform into a broadcast of a hosted event, and transmitting the broadcast comprising the content from the hosted event and the audience data feeds associated with a plurality of data sources.

### RELATED APPLICATION

Under provisions of 35 U.S.C. § 119(e), the Applicant claims benefit of U.S. Provisional Application No. 63/391,145 filed on Jul. 21, 2022, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to a process for generating an interactive audience environment from a plurality of content service providers.

### BACKGROUND

In some situations, users may attend an online event from a plurality of different platforms. For example, there may be an event hosted on a first online platform, to participate with the hosts of the event, the audience traditionally must use the same platform as the host. Further, current online platforms merely connect user data feeds to a common stream. Therefore, producing an interactive online event with audience data streams from a plurality of different platforms often causes problems because audience members not on the platform hosting the event cannot interact with the event. Additionally, when an audience joins an online event an unprocessed version of the audience data is conventionally incorporated into the event causing interactivity issues not limited to misunderstandings, interruptions, and decreased audience engagement.

### BRIEF OVERVIEW

A multi-platform web-event hosting and production system may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure provide a platform for hosting a web event with audience members from a plurality of different online platforms. The system may be configured to host an online event on an audio-visual enabled network. In some embodiments according to the present disclosure, the platform may enable mixing and production of the received data to facilitate interaction between the host and the audience across the multiple audience platforms. For example, audience data streams and host data streams may be combined to create a professionally produced transmission stream. In some embodiments of the present disclosure, the production server may automatically incorporate modified data from the production server into a transmission stream using artificial intelligence or machine learning. Other embodiments of the present disclosure may enable a user to select particular audience data streams, from among the plurality of extracted audience data streams, to be included in the broadcast or transmission of the hosted event.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing multi-platform web-event hosting and production process; and

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of web-event hosting and production across multiple platforms embodiments of the present disclosure are not limited to use only in this context.

### I. System Overview

Consistent with embodiments of the present disclosure, a multi-platform web-event hosting and production system may be provided. This overview is provided to introduce a selection of concepts in a simplified form that are further described below. This overview is not intended to identify key features or essential features of the claimed subject matter. Nor is this overview intended to be used to limit the claimed subject matter's scope. The multi-platform web-event hosting and production system may be used by individuals or companies to host and produce an interactive event using a plurality of different audience interaction platforms. The claimed subject matter may enable the host of the interactive event to modify raw audience data streams and control the output transmitted back to the audience.

Embodiments of the present disclosure generally relate to producing and hosting an online event using a plurality of different content sources. The multi-platform web-event hosting and production system enables audience members from a plurality of different online platforms to interact with (e.g., listen to, watch, participate in) an online event. Audience data streams may be extracted from the platform that the audience member used to join the event. A plurality of audience data streams may be combined in an event production module. The event production module may combine data from the host of the event, the extracted audience data streams, and/or other content associated with the event. During the event, the production module may control how all of the received data is processed and displayed to produce the interactive event. For example, the production module may determine which audience members are able to directly interact with the host, configure the content being displayed on the transmission stream, and/or modify data stream properties of the audience data streams extracted from the audience platforms and/or host data streams from the host platform.

Conventionally, interactive communication required audience members to utilize the same online event platform as the host. In contrast, the present application discloses utilizing the production module to extract audience members raw data feeds and enable cross-platform interaction for an online event. Use of the production module may enable an audience member on any platform to interact with the event as if they had joined the event on the same online platform as the host. The system may enable two-way communications between a host on a first platform and audience members on one or more other platforms, thereby enabling a multi-platform production of an online event.

The multi-platform web-event hosting and production system may enable professional level audio and/or video control over the received host data, audience data, and transmission stream. For example, one or more audience members may be selected from among a plurality of audience member to interact with the host of the event. As other examples, the multi-platform web-event hosting and production system may modify parameters of the audience data stream in real time, and/or add graphics and/or other stream content to the transmitted stream in real-time during the event. In further embodiments, the system may create the transmission stream after the event takes place.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. System Configuration

According to the present disclosure, the system utilizes a plurality of networked servers to enable a multi-platform web-event hosting and production process. The broadcast production server 140 is configured to interface with a plurality of online meeting platforms and extract users' raw data streams from the meeting platforms to aggregate the audience data onto a centralized server. In some embodiments, users may join an event associated with the centralized server to allow for the extraction of the user data. Other embodiments enable a computer program to extract user data from an online meeting platform from the audience members local device.

Once the audience data streams have been sent to the production server, the production module can then modify and edit the received data to produce the online event. For example, the production module can be an artificial intelligence or machine learning based model that can utilize event parameters to determine how to produce the received content for the transmission stream. Other embodiments may provide an interface where the online event can be created and modified in real time during the online event.

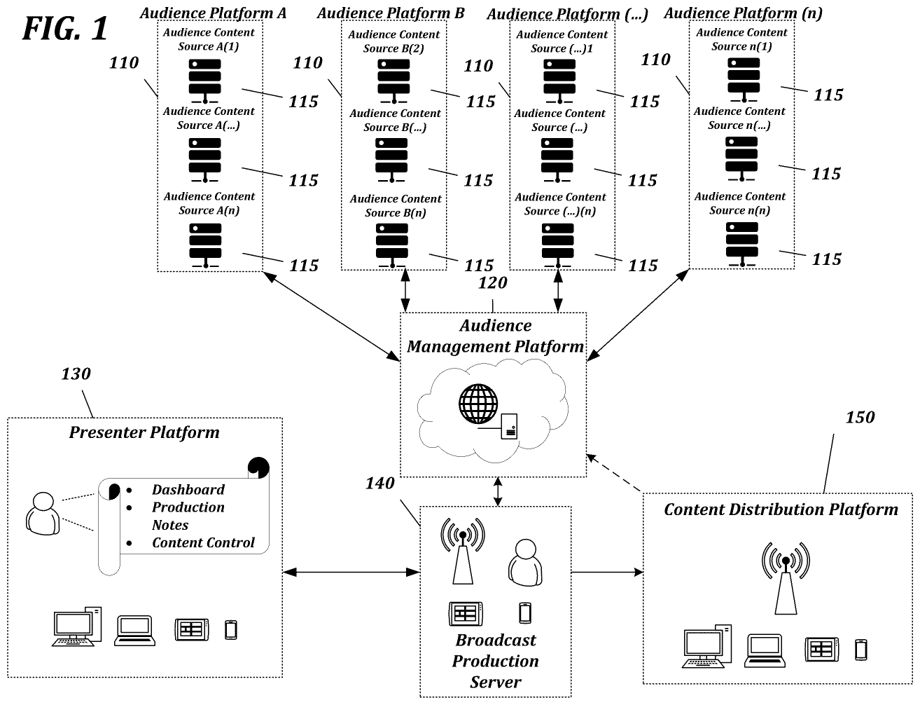

FIG. 1 illustrates one possible operating environment through which a platform consistent with embodiments of the present disclosure may be provided. By way of non-limiting example, a multi-platform web-event hosting and production process may comprise a plurality of audience platforms 110, an audience management platform 120, a presenter platform 130, a broadcast production platform 140, and a content distribution platform 150.

Each Audience platform 110, may be associated with an online meeting platform such as Zoom, Google Meet, WebEx, Facetime, and/or any other online platform that provides two-way communication between the audience member and a presenter and/or two-way communication among audience members as peers. Each audience platform 110 of the plurality of audience platforms may comprise a plurality of audience content sources 115. Each audience content source 115, may provide a plurality of data streams to the audience platform 110. In some embodiments of the present disclosure, one or more (e.g., each) audience content source 115 may comprise a video stream, an audio stream, a data stream, and/or a text stream to the audience platform 110.

In some embodiments of the present disclosure, one or more (e.g., each) of the plurality of audience platforms 110 may be connected to the audience management platform 120. The Audience platform 110 may connect to the audience management platform 120 through a networked connection between the audience platform 110 and the audience management platform 120. In some embodiments of the present disclosure, the audience management platform 120 may interface with an API, SDK, or other development tool to extract one or more (e.g., each) of the audience content sources 115 from the audience platform 110.

Additionally or alternatively, the audience management platform 120 may interact with one or more of the audience platforms 110 to directly capture one or more (e.g., each) of the audience content source 115s from the audience platform 110. For example, the audience management platform 120 may interface with the audience platform 110 by connecting to the audience content source 115. The audience management platform 120 may be hosted on a centralized server, such as, for example, a cloud computing service. A user may access the audience management platform 120 through the audience platform 110 that is connected to the audience management platform 120. In other embodiments, the audience platform 110 may utilize a software application to interface with the audience management platform 120. The software application to interface between the audience platform 110 and the audience management platform 120 may be embodied as, for example, but not be limited to, a website, a web application, a desktop application, mobile device application, and/or a mobile application compatible with a computing device.

The audience management platform 120 may transmit data retrieved from the plurality of audience content sources 115, to the broadcast production server 140. Broadcast production server 140 may comprise a plurality of automatic and/or manual tools for modifying the audience content sources 115 collected by the audience management platform 120 to produce an event. For example, the broadcast production server 140 may normalize the volumes of the received audience content sources 115 from the plurality of audience platforms 110. In some embodiments of the present disclosure, the broadcast production server 140 may perform live video editing and production on at least one audience content source, of the plurality of audience content sources 115. In one example, the broadcast production server 140 may employ a machine learning algorithm to determine and apply modifications to at least a portion of the plurality of audience content sources 115 from the audience management platform 120. In other embodiments of the present disclosure, the broadcast production server 140 may generate metrics or other information about the hosted event. For example, the broadcast production server 140 may generate dashboards, event notes, and/or audience data depending on the nature of the hosted event. In some embodiments, the broadcast production server 140 may be configured to add hosted event materials to the plurality of data streams. In some embodiments, the broadcast production server 140 may add animations, advertisements, annotations, and/or other digital elements to the hosted event.

In some embodiments, the system may include a presenter platform 130 connected to the broadcast production server 140. For example, the presenter platform 130 may be locally connected to the broadcast production server 140. In other embodiments, the presenter platform 130 may connect to the broadcast production server 140 over a network. The presenter platform 130 may receive data from the broadcast production server 140, such as dashboards, event notes, and/or audience data depending on the nature of the hosted event. In some embodiments, the presenter platform 130 may transmit a plurality of presenter data streams to the broadcast production server 140 including, at least one of a video stream, an audio stream, a text stream, a data stream, and/or a stream including other hosted event data. For example, the presenter platform 130 may transmit audio and video data to the broadcast production server 140. In some embodiments, the presenter platform 130 may control content provided to the broadcast production server 140. For example, the presenter platform 130 may select at least one audience content source, of the plurality of audience content sources 115 aggregated at the audience management platform 120. The presenter platform 130 may interface with the selected audience content sources 115 through the broadcast production server 140 to host an interactive event. In some embodiments of the present disclosure, the presenter platform 130 may be used to control how audience content sources 115 are modified by the broadcast production server 140 for the hosted event. In some embodiments of the present disclosure the system may utilize the software provided by the Cinamaker™ suite of products and services provided by Cinamaker LLC to assist in the production of the hosted event.

As the hosted event is produced on the production server 140, the produced event may be transmitted using the content distribution platform 150. In some embodiments of the present disclosure the content distribution platform 150 may transmit the hosted event back to the audience platforms 110 through the audience management platform 120. In other embodiments, the content distribution platform 150 may broadcast the hosted event over a plurality of networks such that the hosted event is publicly accessible. For example, the content distribution platform 150 may generate a stream of the hosted event from the data received from the broadcast production server 140, in some embodiments of the present disclosure the content distribution platform 150 may transmit or otherwise deliver the hosted event to any platform that can integrate the data feed distributed by the content distribution platform 150. The content distribution platform 150 may transmit the produced event data feed in real-time or substantially in real time, such that the transmission of the produced event may facilitate the audience content source 110 and the presenter platform 130 to communicate substantially in real-time.

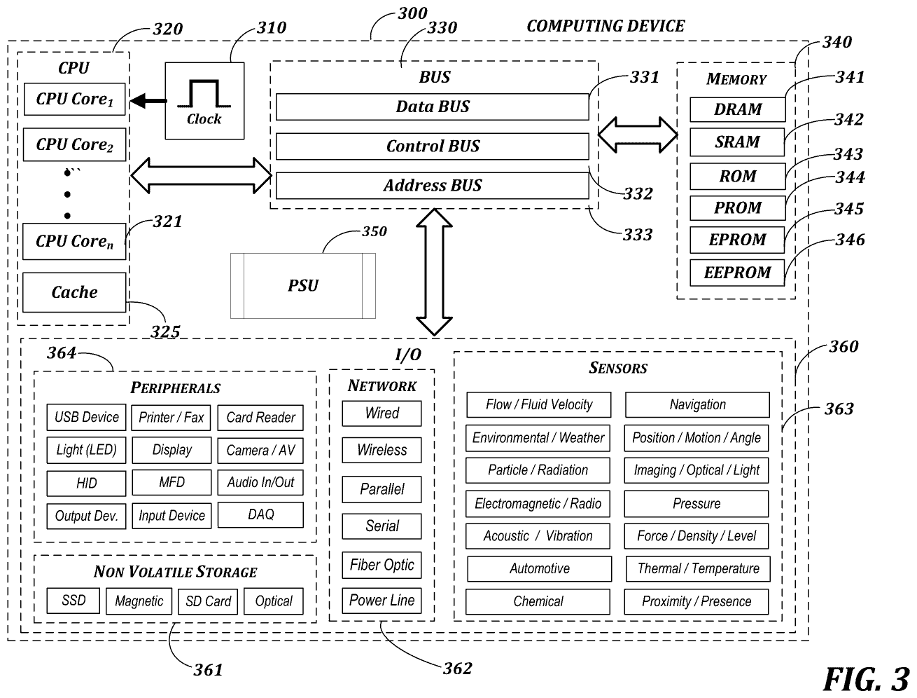

As will be detailed with reference to FIG. 3 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### III. System Operation

Embodiments of the present disclosure provide a platform for hosting a web event with audience members from a plurality of different online platforms. The system may be configured to host an online event on an audio-visual enabled network. Participants of the event may join using a plurality of different audience platforms 110. The data received from audience members, hosts, and any production crew may include at least one of a camera feed, video feed, and/or audio feed associated with a participant of the online event.

In some embodiments according to the present disclosure, the platform may enable mixing and production of the received data to facilitate interaction between the host and the audience across the multiple audience platforms. For example, the mixing and production may enable one or more features such as: digital audio interfacing, digital video interfacing, equalization, volume control, and/or other audio-visual systems. The process may also enable production content to be added to the user's data streams in real-time to generate the transmission stream for the hosted event.

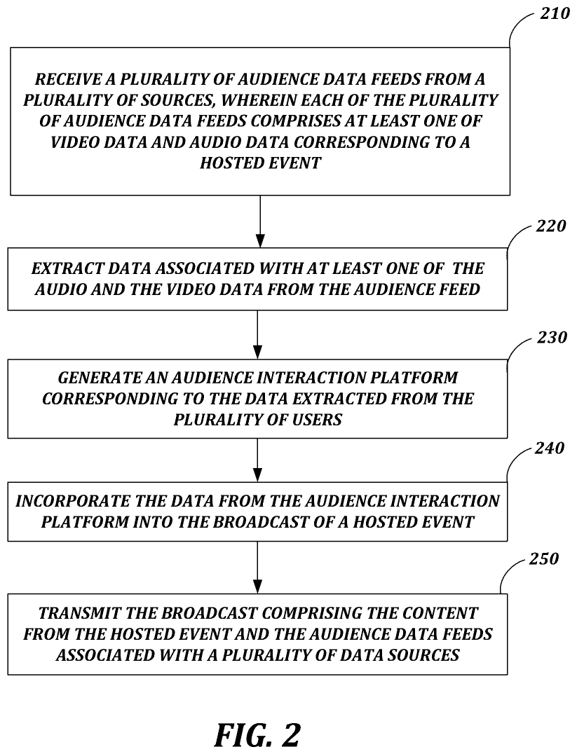

FIG. 2 is a flow chart setting forth the general stages involved in a method 200 consistent with an embodiment of the disclosure for providing multi-platform web-event hosting and production process platform. The method may be implemented using a computing device 300 as described in more detail below with respect to FIG. 3.

Although the method has been described to be performed by computing device 300, it should be understood that, in some embodiments, different operations may be performed by different networked elements in operative communication with computing device 300. For example, computing device 300 may be employed in the performance of some or all of the stages in method 200.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where computing device 300 may receive a plurality of audience data feeds from a plurality of sources, wherein each of the plurality of audience data feeds comprises video data and/or audio data corresponding to a hosted event. For example, the audience data feeds may correspond to a plurality of audience content sources associated with an audience platform. In some embodiments, each audience content source may be associated with a different audience platform, such that the audience content sources may be received from a plurality of different independent audience platforms, such as online meeting platforms (e.g., Teams, Zoom, WebEx, Google Meet, FaceTime, etc.). In embodiments, the various independent audience platforms may be incapable of communicating directly with one another. The data feeds associated with each audience content source may comprise audio, video, text, and/or other communication related data associated with the audience data stream. The data feeds may be received from a server connected to the internet or accessed through a cloud system or received from a local input.

From stage 210, where computing device 300 may receive a plurality of audience data feeds from a plurality of sources, method 200 may advance to stage 220 where computing device 300 may extract data associated with at least one of the audio data and the video data from one or more (e.g., each) of the plurality of audience data feeds. For example, the data may be extracted from an audience data feed associated with an audience content source that represents an audience member using a first audience platform. The computing device may utilize an SDK or API associated with the first audience platform to extract the data from the audience data feed. After extraction, the data may be transferred to a production server. In other embodiments, the computing device may extract data from an audience data feed associated with the audience content source directly from an input device connected to the production server, like, for example, the presenter platform 130. Extracting the data from the audience data feed may include extracting metadata associated with the audience data feed. In some embodiments, the computing device may add one or more stream tags to the extracted data from the audience data feed. Accordingly, once the data has been received by the production server, producing the hosted event may occur in real time such that a transmission stream may be generated, corresponding to the hosted online event.

Once computing device 300 extracts data associated with at least one of the audio and the video data from the at least one audience feed in stage 220, method 200 may continue to stage 230 where computing device 300 may generate an audience interaction platform using the data extracted from the one or more audience data feeds. For example, the extracted data may be combined using the production server. In some embodiments, the production server may generate an interface that displays information relating to the extracted data from the one or more audience members. Further, in some embodiments, the interface may enable modifications to be made to the data stream. Some embodiments may allow a user (e.g., the presenter, a producer, etc.) to interact with the interface to modify the audience data streams for the produced event. In other embodiments, the production server may be configured to automatically modify the received data streams. In embodiments, the production server may display at least a portion of the modified data streams in the interface or otherwise populate the interface with the modified data streams.

After computing device 300 generates the audience interaction platform in stage 230, method 200 may proceed to stage 240 where computing device 300 may incorporate the data from the audience interaction platform (e.g., the interface comprising the modified data streams) into a broadcast or other transmission of the hosted event. To generate the transmission of the hosted event, at least a portion of the data of the transmission may be modified (e.g., produced) and mixed by the production server. The produced and mixed data may then be transmitted to the audience. In some embodiments, the production and mixing may happen in real-time or substantially real-time as data is received. Some embodiments enable modifications from production and mixing to be made directly to a generated transmission stream. The transmission stream may be controlled by the production server to choose which networks the transmission stream should be broadcast or transmitted on.

For example, audience data streams and presenter data streams may be combined to create a professionally produced transmission stream. In some embodiments of the present disclosure, the production server may automatically incorporate modified data from the production server into a transmission stream. Other embodiments of the present disclosure may enable a user (e.g., the presenter, a producer, etc.) to select particular audience data streams, from among the plurality of extracted audience data streams, to be included in the broadcast or transmission of the hosted event. Some embodiments of the present disclosure may facilitate interaction between users (e.g., interaction between the host(s)/presenter(s) and one or more audience members and/or among audience members) associated with the extracted data streams included in the broadcast or transmission. For example, when the data has been incorporated into the broadcast or transmission of the stream, users may be able to interact with other members of the broadcast through video, text, and/or audio communication. In some embodiments incorporating the data from the audience interaction platform may include incorporating additional data elements created specifically for the broadcast, such as advertisements, animations, images, annotations, or other creative elements related to the event.

In some embodiments of the present disclosure, a presenter data stream associated with a first online platform may facilitate interaction with an audience member participating in the online event using a second online platform. For example, the process may extract the data feeds associated with the first online platform of the presenter and the second online platform of the audience member into a production server. The production server may modify the audience data feed and the presenter data feed to change one or more audio-visual properties associated with the audience data feed and/or the presenter data feed. In some embodiments, the system may apply editing tools to one or more (e.g., each) of the data feeds before the data feeds are included in the broadcast or transmission. Each data feed may comprise audio data, video data, computer generated images, animations, text, and/or other content associated with the audience or the presenter. In some embodiments, the production server may add content directly into the transmission stream. For example, the production server may be used to add animations, pre-recorded videos, advertisements, images, annotations, and/or other content associated with the hosted event to the transmission stream.

Additional embodiments of the present disclosure may facilitate interaction between a first user associated with a presenter data stream and a second user associated with an audience data stream. In further embodiments there may be multiple presenter data streams and/or multiple audience data streams. In some embodiments of the present disclosure, the process may utilize an API/SDK to access at least one of the audience data streams or the presenter data streams. Embodiments of the present disclosure may utilize a plurality of APIs or SDK's corresponding to the different platforms used by the plurality of audience members to access the event.

Further embodiments of the present disclosure may include the production server comprising a hosting portion and an editing portion. The hosting portion of the production server may aggregate and modify data streams received by the production server. The hosting portion of the production server may extract metadata from the data received by the production server. In further embodiments the production server may add stream tags to each of the plurality of data streams received by the production server. In some embodiments the production server may automatically edit the data streams to create the transmission stream. For example, the production server may edit the data streams based at least in part on the metadata associated with the data streams. As a particular example, the production server may add a stream tag to each data stream to be included in a transmission stream. Thereafter, the production server may assemble all streams comprising the stream tag metadata for inclusion in the transmission stream. In other embodiments of the present disclosure, the production server may provide a user interface for a user (e.g., the presenter, a producer, etc.) to select how to modify the plurality of received data streams. For example, the interface may allow a user to normalize or otherwise modify the volume of audio data from a stream, to modify the video content of a received data stream, to add text subtitles to a received data stream, to blur video content of a received data stream, and/or any other modification.

In some embodiments, the mixing and production may be automatically performed by a machine learning neural network or other artificial intelligence to mix and produce the transmission stream according to one or more transmission data stream requirements, one or more user preferences, or any other measurable criteria. The process may determine the transmission data stream requirements based on networking parameters to facilitate interaction between the event host and the audience. In some embodiments, the networking parameters may be determined by the machine learning neural network.

After computing device 300 incorporates the data from the audience interaction platform into the broadcast of the hosted event in stage 240, method 200 may proceed to stage 250 where computing device 300 may transmit the broadcast comprising the transmission stream, including the content from the hosted event and the audience data feeds associated with a plurality of data sources. For example, the broadcast may be transmitted to a plurality of different destinations and across a plurality of different media, such as websites, television, and/or other media hosting platforms. In some embodiments of the present disclosure the broadcast may be transmitted to one or more of the online platforms associated with the audience data streams.

In some embodiments, the broadcast may be transmitted back through a data stream associated with the audience to provide the broadcast to one or more online platforms associated with the audience members. Once computing device 300 transmits the broadcast comprising the content from the hosted event and the audience data feeds associated with a plurality of data sources in stage 250, method 200 may then end at stage 255.

### IV. Platform Architecture

The multi-platform web-event hosting and production process may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the multi-platform web-event hosting and production platform may be hosted on a centralized server, such as, for example, a cloud computing service. Although method 200 has been described to be performed by a computing device 300, it should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of method 200.

FIG. 3 is a block diagram of a system including computing device 300. Consistent with an embodiment of the disclosure, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device, such as computing device 300. In a basic configuration, computing device 300 may include at least one processing unit 302 and a system memory 304. Depending on the configuration and type of computing device, system memory 304 may comprise, but is not limited to, volatile (e.g., random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 300's operation. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 may perform processes including, for example, one or more of method 200's stages as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method comprising:
receiving a plurality of audience data feeds from a plurality of data sources, wherein each of the plurality of audience data feeds comprises at least one of video data or audio data corresponding to a hosted event;
extracting data associated with at least one of the audio data and the video data from a subset of the plurality of audience data feeds;
generating an audience interaction platform corresponding to the data extracted from the subset of the audience data feeds;
incorporating the data from the audience interaction platform into a transmission stream of a hosted event; and
transmitting the transmission stream to the plurality of data sources.

2. The method of claim 1, further comprising:
receiving a presenter data feed comprising at least one of video data and audio data; and
transmitting the transmission stream to a device from which the presenter data feed is received.

3. The method of claim 2, wherein generating the audience interaction platform comprises:
extracting presenter data associated with at least one of the audio data and the video data from the presenter data feed;
modifying at least one property of one or more of the extracted audio data or the extracted video data of the subset of audience data feeds; and
combining the modified audience data feeds with the extracted presenter data to form the interaction platform.

4. The method of claim 3, wherein the presenter data feed comprises a data stream, and wherein modifying the audience data feeds comprises modifying the audience data feeds based on data received via the presenter data stream.

5. The method of claim 3, wherein modifying the audience data feeds comprises modifying the audience data feeds using a machine learning model based on one or more specified feed criteria.

6. The method of claim 1, wherein the plurality of audience platforms comprises a plurality of independent audience platforms that are incapable of communicating directly with one another.

7. The method of claim 6, wherein transmitting the transmission stream to the plurality of data sources allows users associated with the plurality of user data feeds to interact with other recipients of the transmission through at least one of video, text, or audio communication in substantially real time.

8. The method of claim 1, wherein incorporating the data from the audience interaction platform into a transmission stream of a hosted event comprises incorporating at least one of an animation, a pre-recorded video, an advertisement, an images, or an annotation to the transmission stream.

9. The method of claim 1, further comprising transmitting the transmission stream to one or more of a website, a television broadcast platform, or a media hosting platforms.

10. A system comprising:
at least one device including a hardware processor;
the system being configured to perform operations comprising:
receiving a plurality of audience data feeds from a plurality of data sources, wherein each of the plurality of audience data feeds comprises at least one of video data or audio data corresponding to a hosted event;
extracting data associated with at least one of the audio data and the video data from a subset of the plurality of audience data feeds;
generating an audience interaction platform corresponding to the data extracted from the subset of the audience data feeds;
incorporating the data from the audience interaction platform into a transmission stream of a hosted event; and
transmitting the transmission stream to the plurality of data sources.

11. The system of claim 10, wherein the operations further comprising:
receiving a presenter data feed comprising at least one of video data and audio data; and
transmitting the transmission stream to a device from which the presenter data feed is received.

12. The method of claim 11, wherein generating the audience interaction platform comprises:
extracting presenter data associated with at least one of the audio data and the video data from the presenter data feed;
modifying at least one property of one or more of the extracted audio data or the extracted video data of the subset of audience data feeds; and
combining the modified audience data feeds with the extracted presenter data to form the interaction platform.

13. The system of claim 12, wherein the presenter data feed comprises a data stream, and wherein modifying the audience data feeds comprises modifying the audience data feeds based on data received via the presenter data stream.

14. The system of claim 12, wherein modifying the audience data feeds comprises modifying the audience data feeds using a machine learning model based on one or more specified feed criteria.

15. The system of claim 10, wherein the plurality of audience platforms comprises a plurality of independent audience platforms that are incapable of communicating directly with one another.

16. The system of claim 15, wherein transmitting the transmission stream to the plurality of data sources allows users associated with the plurality of user data feeds to interact with other recipients of the transmission through at least one of video, text, or audio communication in substantially real time.

17. The system of claim 10, wherein incorporating the data from the audience interaction platform into a transmission stream of a hosted event comprises incorporating at least one of an animation, a pre-recorded video, an advertisement, an images, or an annotation to the transmission stream.

18. The system of claim 10, wherein the operations further comprising transmitting the transmission stream to one or more of a website, a television broadcast platform, or a media hosting platforms.

19. One or more non-transitory computer readable media comprising instructions which, when executed by one or more hardware processors, causes performance of operations comprising:
receiving a plurality of audience data feeds from a plurality of data sources, wherein each of the plurality of audience data feeds comprises at least one of video data or audio data corresponding to a hosted event;
extracting data associated with at least one of the audio data and the video data from a subset of the plurality of audience data feeds;
generating an audience interaction platform corresponding to the data extracted from the subset of the audience data feeds;
incorporating the data from the audience interaction platform into a transmission stream of a hosted event; and
transmitting the transmission stream to the plurality of data sources.

20. The non-transitory computer readable media of claim 19, further comprising:
receiving a presenter data feed comprising at least one of video data and audio data;
transmitting the transmission stream to a device from which the presenter data feed is received,
wherein generating the audience interaction platform comprises:
extracting presenter data associated with at least one of the audio data and the video data from the presenter data feed;
modifying at least one property of one or more of the extracted audio data or the extracted video data of the subset of audience data feeds; and
combining the modified audience data feeds with the extracted presenter data to form the interaction platform.
